(19) United States
(12) Patent Application Publication
(10) Pub. No.: US 2007/0023496 A1
(43) Pub. Date: Feb. 1, 2007

(54) House arrest apparatus

(76) Inventor: Christopher J. Hall, Satellite Beach, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/403,541

(22) Filed: Apr. 13, 2006

Related U.S. Application Data
(60) Provisional application No. 60/670,807, filed on Apr. 13, 2005.

(51) Int. Cl. G06F 17/00

(52) U.S. Cl. 235/375

(57) ABSTRACT

A method and apparatus for determining a location of a person or object. A device is affixed to the person or the object and the location of the person/object determined according to various location determining techniques. Location information is sent to a supervising authority directly from a communications element of the device or through intermediate communications elements. Terrestrial-based signals can be used to determine location.

### The present invention claims the benefit of the provisional patent application filed on Apr. 13, 2005, and assigned application No. 60/670,807.

### FIELD OF THE INVENTION

The present invention relates generally to location apparatuses and processes, and more specifically to determining a location of an individual and a process for determining the location.

### BACKGROUND OF THE INVENTION

A prior art body worn house arrest device generally comprises a bracelet or anklet worn by an offender (or other body-worn devices that the offender typically cannot remove without causing a tamper indication) that monitors and tracks the offender to ensure compliance with a court order or other travel restrictions. The prior art anklet/bracelet comprises a proprietary radio frequency (RF) transmitter that communicates unidirectionally with a fixed base station in the offender's home, for example. See FIG. 1. Typically, the offender is required to remain within a short distance of the base station, as limited by the transmitting range of the anklet or bracelet. To confirm the offender's location, the bracelet transmits a signal to the base station on a predetermined schedule. Failure to receive the signal indicates that the offender may have traveled outside the permitted range, causing the base station to alert a supervising authority via a telephone land line connection, unless such a departure is permitted, such as to travel to a work location. The base station may also provide a compliance report to the supervising authority on a predetermined schedule or responsive to interrogation by the supervising authority. Tracking the offender in locales where a base station is not present is not easily accomplished.

To improve the communications and location-determining capabilities of the house arrest apparatus, another prior art device incorporates a cellular, PCS, trunking radio or other comparable radio communication subscriber unit into the bracelet, eliminating the requirement for a base station communicating over a landline link to the supervising authority. The bracelet further comprises a GPS (global positioning system) location determining element (receiver), instructions regarding permitted and prohibited locations and a time schedule associated with the locations. That is, departure from a permitted location or approach to a prohibited location at a prohibited time may generate a warning to the supervising authority. The prior art device can be interrogated via a communications link to the supervising authority to report its current location and download location logs from the bracelet to the supervising authority.

Yet another prior art device includes the anklet or bracelet that communicates with a portable base station that reports to the monitoring authority over a cellular, PCS, trunking radio or comparable radio subscriber unit and/or a landline. The portable base station can further include a GPS receiver and a location recording device. The portable device further includes the permitted and prohibited locations as described above. In this system a one-way RF link is still utilized between the bracelet and portable base station to assure the monitored person is within range of the portable base station. Such a portable base station usually utilizes a GPS receiver to determine its location and includes GPS-derived location information in its reports to the monitoring authority.

According to a related prior art system, the anklet/bracelet includes a GPS receiver and a location recording device or communicates with a portable base station that includes a GPS receiver and recorder. The recorded data is downloaded to the base station then to the supervising authority via landline when the anklet/bracelet is within range of the base station. This embodiment cannot detect a location violation at the time of occurrence and is therefore intended for low risk violators.

Various disadvantages are associated with these prior art systems. Certain prior art systems depend on a landline-based base station whose physical location is verified by its attachment to a particular landline. Any systems employing a GPS-based receiver are rendered nonfunctional when the GPS receiver cannot receive the necessary GPS signal. For example, for those systems where the GPS receiver is mounted on the bracelet or other body-worn device, location cannot be determined when the offender is within a metal structure, such as a building or a vehicle.

### BRIEF SUMMARY OF THE INVENTION

One embodiment of the present invention comprises a system for monitoring a location of an object. The system further comprises a first device affixed to the object and comprising a first communications device; a second communications device for communicating with the first communications device, the first communications device having a shorter range than the second communications device; and a base station for communicating with the second communications device, wherein a location of the base station is known, and wherein responsive to a signal from the second communications device the base station determines that the object is proximate the location.

### BRIEF DESCRIPTION OF THE DRAWINGS

The present invention can be more easily understood and the advantages and uses thereof more readily apparent when the following detailed description of the present invention is read in conjunction with the figures wherein:

FIG. 1 is a block diagram depicting a prior art house arrest apparatus.

FIGS. 2-7 are block diagrams depicting various embodiments of the present invention.

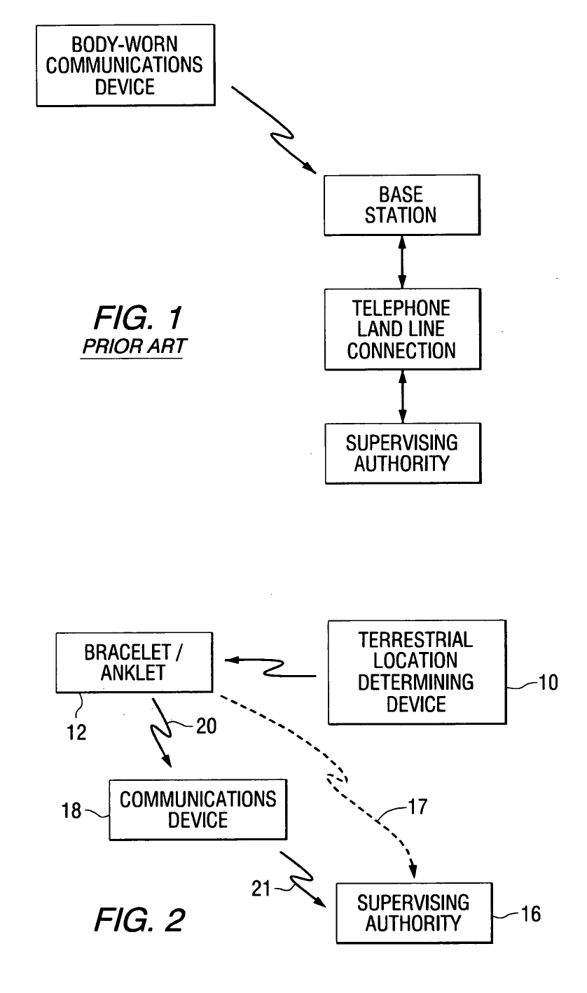

In accordance with common practice, the various described features are not drawn to scale, but are drawn to emphasize specific features relevant to the invention. Like reference characters denote like elements throughout the figures and text.

### DETAILED DESCRIPTION OF THE INVENTION

Before describing in detail exemplary methods and apparatuses related to a house arrest apparatus, it should be observed that the present invention resides primarily in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the invention.

Within the description of the invention the phrase “anklet/bracelet” refers to any body worn device that is not removable (or removable only by actuating a tamper indicating device), by a person (or object) whose location is to be monitored. The person may be required to remain within a specified distance of one or more fixed geographical locations, may be required to remain within a fixed distance of a movable location-determining device and/or may be prohibited from entering within a specified distance of one or more fixed geographical locations.

For the purposes of this document, when referring to the features of the current invention, the term ‘GPS’ is inclusive of GLONASS and/or any satellite or terrestrial radio-based positioning system, including cellular, PCS, trunking or comparable radio systems that are capable of providing position information. Such position information can be determined from enhanced-911 phase II cellular systems, PCS, trunking or comparable systems using such technologies as assisted GPS and/or uplink time difference of arrival to provide location based services or positioning services.

Further, for the purposes of this document, when referring to the features of the current invention cellular, PCS, trunking or comparable radios systems (mentioned singly or in combination) include, but are not limited to comparable systems utilizing the 800 MHz band, 1900 MHz band, 700 MHz band, the AWS band, the 1.6-1.7 GHz band, and/or the 2.5-2.6 GHz (IMT-2000) band and/or any others which are allocated or reallocated by the FCC for comparable mobile communications, including voice and/or data.

In one embodiment of the present invention the prior art GPS satellite based location determination is supplemented or replaced by terrestrial location services such as those available by utilizing cellular system and/or cellular subscriber unit capabilities deployed primarily for compliance with the FCC cellular “Phase II Enhanced 911” mandate. This mandate requires system and/or subscriber based capabilities to locate “911” cellular callers within specified accuracy and reliability parameters. It also provides a capability to locate any cellular device on demand responsive to the user calling a designated number(s) (i.e., a number other than the designated “911” number). The system can also interrogate a subscriber unit to determine its location.

Thus this feature of the present invention avoids the disadvantages of the prior art by providing a location determination technique when the GPS-based location determination is not available, as for example when a link to a GPS satellite is obscured or not available. The location determination technique can be used to supplement, assist or supplant the GPS-based location determination.

FIG. 2 illustrates one embodiment of the invention wherein a terrestrial location determining device 10 supplies location information to a bracelet/anklet 12 worn by an offender or someone whose position is to be monitored. The location determining device 10 further comprises a cellular system or other land-based systems providing the ability to determine a location of a receiving site, i.e., the bracelet/anklet 12. That is, in one embodiment, the bracelet/anklet 12 can determine its location based on signals received from the terrestrial location determining device 10, such as by suing time-difference of arrival techniques. The bracelet/anklet 12 communicates with a supervising authority 16 either directly over a communications link 17 or through a communications device 18 (comprising one of the various communications devices operative with the bracelet/anklet 12 as described below) via communications links 20 and 21. The unidirectional links 17, 20 and 21 are merely exemplary and in one embodiment comprise bidirectional links. Any acceptable communications protocol (based on a protocol standard or a proprietary protocol) can be used to implement the links 17, 20 and 21.

In another embodiment, the current invention teaches use of one or more radio transmitting beacons to provide position information at specific locations, such as the offender's home, workplace, vehicle, or other permitted locations where GPS or cellular location services may not perform in the desired manner or with the desired reliability. The bracelet/anklet receives one or more beacon signals from which it can determine its location or if the location information is included within the beacon signal, the bracelet/anklet can determine its position from a beacon signal directly. The location information is provided to the supervising authority from the bracelet/anklet directly or via one of the various communications devices operative with the anklet/bracelet as described further below. To avoid tampering, the beacons should be placed in locations that are not easily accessible or the beacons should include a tamper proof indicators.

In yet another embodiment, transmitting beacons are placed at locations where the offender's presence is excluded (for example, schools in the case of a sex offender or the home of a person who the offender has been ordered not to approach).

The radio beacons may provide location information to the bracelet/anklet (or another offender-carried device such as a portable base station), based on the beacon's known fixed location. In such an application the beacons can be placed in a tamper-resistant or tamper-indicating manner. Alternatively, the beacons can use GPS location techniques, especially if the beacon is used in a mobile application such as the offender's car, and can thereby provide the location information to the anklet/bracelet, or another offender carried device, from which it is communicated to the supervising authority either directly or via one of the various communications devices operative with the anklet/bracelet as described below.

The beacons may alternatively communicate bidirectionally with the offender-carried equipment if the latter is capable of a bidirectional operation. In such an embodiment the beacons can record the location of the offender (or the offender's presence within a specified distance of the beacon), trigger a local alarm to those in exclusion areas and/or send an alarm to the supervising authority.

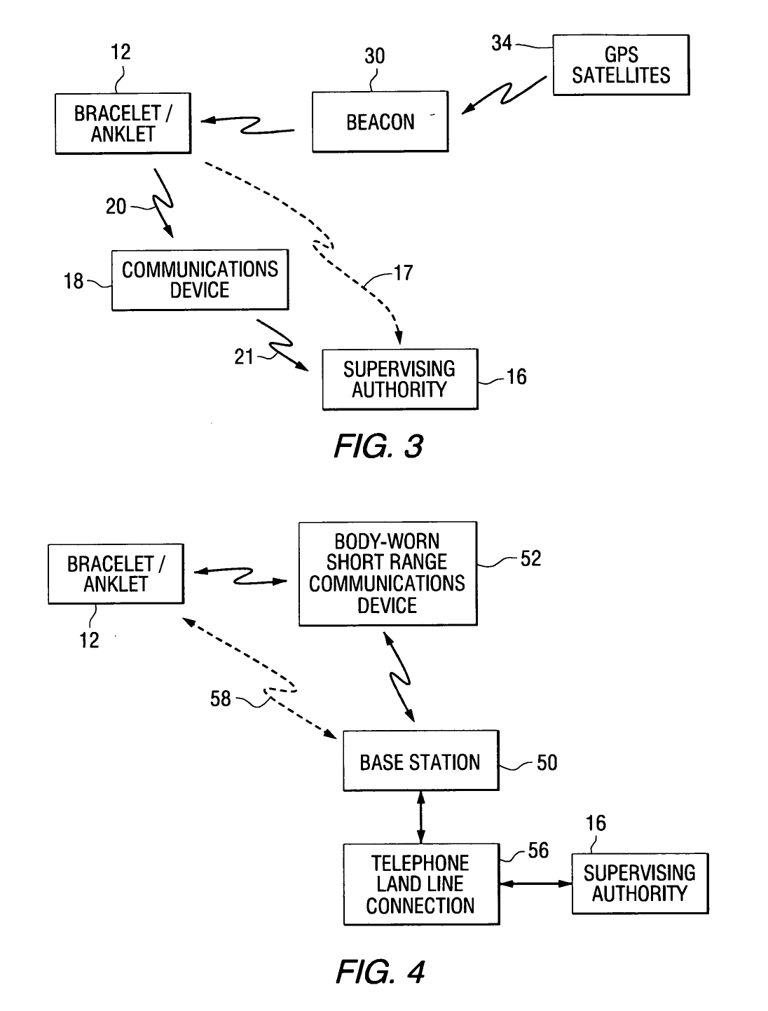

FIG. 3 illustrates one embodiment of the invention wherein a beacon 30 supplies location information to the bracelet/anklet 12, the location information based on a fixed (tamper-proof) location of the beacon 30 or as determined from information supplied from GPS satellites 34. The bracelet/anklet 12 communicates with the supervising authority 16 either directly over the communications link 17 or through the communications device 18 via the communications links 20 and 21. The unidirectional links 17, 20 and 21 are merely representative and in one embodiment comprise bidirectional links. Any acceptable communications protocol (based on a protocol standard or a proprietary protocol) can be used to implement the links 17, 20 and 21.

According to another embodiment of the present invention (see FIG. 4), a house arrest apparatus comprises a base station 50 that monitors the presence of the anklet/bracelet 12 by communicating with a body-worn short range communications device 52 that in turn communicates with the anklet/bracelet 12. The base station 50 communicates with the supervising authority 16 via a land line telephone connection 56 or over a wired or wireless communications link.

The bracelet/anklet 12 is designed not to be removed without tamper detection. Tamper detection is indicate by a tamper indication element, such as a closure band is broken or unbuckled. A more advanced tamper indication includes a biometric monitor that confirms the presence (possibly including identity) of the wearer using one or more of an IR pulse oximeter, an EKG, a fingerprint reader, a capacitance-measuring device, voice or iris reader, etc. Preferably, the bracelet/anklet 12 is water resistant as the wearer will not be able to remove the device to bathe.

According to the embodiment of FIG. 4, the bracelet/anklet 12 comprises a relatively small, low power communications device that exhibits a relatively long battery life due to its low power transmission feature. Given its low power transmission capability, the bracelet/anklet 12 comprises a relatively short range RF transmitter or transceiver (for bidirectional communications), operating according to a proprietary communications scheme or according to a known communications scheme specifically including, but not limited to, the Bluetooth standard, and/or the 802.11 family of standards or an infrared link for communicating with the body worn short range communications device 52. Other wired or wireless communications protocols can be used for the communications link with the short range communications device 52.

The body-worn short range communications device 52 comprises a transceiver worn by the offender on the hip, in a pocket, etc. for providing a bidirectional communications link between the bracelet/anklet 12 and the base station 50, and provides sufficient battery capacity for communicating with the base station 50, thus reducing the battery capacity requirements of the anklet/bracelet 12 and extending the useful range and battery life of the bracelet/anklet 12. That is, the offender can be afforded a larger permissive range due to the capability of the body-worn short range communications device 52 to close a longer communications link with the base station 50.

Unlike most bracelets/anklets, the battery-powered body-worn short range device 52 may be rechargeable, but it need not be charged while attached to a person's body, enhancing system safety. By shifting the higher power communications functions from the anklet/bracelet 12 to the body-worn short range communications device 52, the bracelet/anklet 12 can be a smaller and lighter unit, due to its reduced power requirements, that is more suitable for wearing by the offender. The body-worn short range communications device 52 can carried by the offender in a purse, pocket, etc., as is a common cell phone.

Generally, in one embodiment the body-worn short range communications device 52 operates as a power booster or repeater for retransmitting signals received from the anklet/bracelet 12 to the base station 50 and vice versa if a bidirectional link is used. According to another embodiment, the body-worn short range communications device 52 operates as a transceiver for receiving and processing signals received from the anklet/bracelet 12 and transmitting a signal representative of the received signal to the base station 50 and vice versa if a bidirectional link is used.

The bidirectional capability of the body-worn short range communications device 52 allows the base station 50 to interrogate the bracelet/anklet 12 through the communications device 52 to determine the offender's current location. In another embodiment (not illustrated) the communications device 52 communicates unidirectionally with the base station 50 to provide offender location information, for example on a predetermined schedule.

In another embodiment, the anklet/bracelet 12 communicates directly with the base station 50 (see the dashed arrowhead 58 in FIG. 4) but in certain embodiments this may require a larger battery than is suitable for wearing by the offender due to the need to send and receive signals over the expected range between the offender and the base station 50, as compared with the shorter range between the anklet/bracelet 12 and the body worn short range communications device 52.

If the anklet/bracelet 12 operates according to the low-power protocol (e.g. a low-power Bluetooth standard), a range of about 10 feet to about 10 meters can be expected, which may be acceptable for communications directly between the anklet/bracelet 12 and the base station 50 in certain applications. Standby power of about 0.3 mW (or less) and about 30 mW when transmitting can be supported by a relatively small battery in the bracelet/anklet 12. Providing a mechanism to switch manually or automatically to high-power operation (e.g., Bluetooth operation) for communicating with the base station 50 increases a ‘walk around’ range to about 100 m, suitable for communications directly between the anklet/bracelet 12 and the base station 50, at the expense of increased battery power consumption.

In those embodiments in which the anklet/bracelet 12 communicates with the base station 50, such communications can be unidirectional or bidirectional (only the latter illustrated by the dashed double arrowhead in FIG. 4). In the unidirectional embodiment, the anklet/bracelet 12 sends a coded transmission indicating its presence within the permitted area. Communications security and/or authentication can be provided by using an encrypted serial number plus time and/or date and/or a simple PRN (pseudorandom number) code or according to various other methods known to those familiar with the art. Other techniques for providing secure communications are known. It is generally considered prudent to use a coded and/or secure communications scheme to prevent a hacker from faking the presence of the body worn bracelet/anklet 12 within the permitted area. Tampering detection can trigger an immediate transmission to the base station 50. The message payload provided by the anklet/bracelet 12 can include offender biometric information and/or tamper indications.

In a bidirectional embodiment, a Bluetooth, 802.11, proprietary or other communications scheme establishes communications with the anklet/bracelet 12 from the base station 50, including any other comparable signal protocol. Alternatively, any query/response signal protocol can be used. The bracelet/anklet 12 transmits messages as a function of time (i.e., according to a predetermined schedule or when polled by the base station 50).

In those embodiments comprising the body-worn short range communications device 52, it communicates unidirectionally or bidirectionally with the anklet/bracelet 12 and with the base station 50 over an RF (such as a Bluetooth link), an IR link, or using any wireless communications protocol. The communications link between the bracelet/anklet 12 and the communications device 52 can also comprise a wired link. The unidirectional and/or bidirectional functionality of the body-worn communications device 52 is similar to the functions provided by the anklet/bracelet 12 in direct communications with the base station 50 as described above.

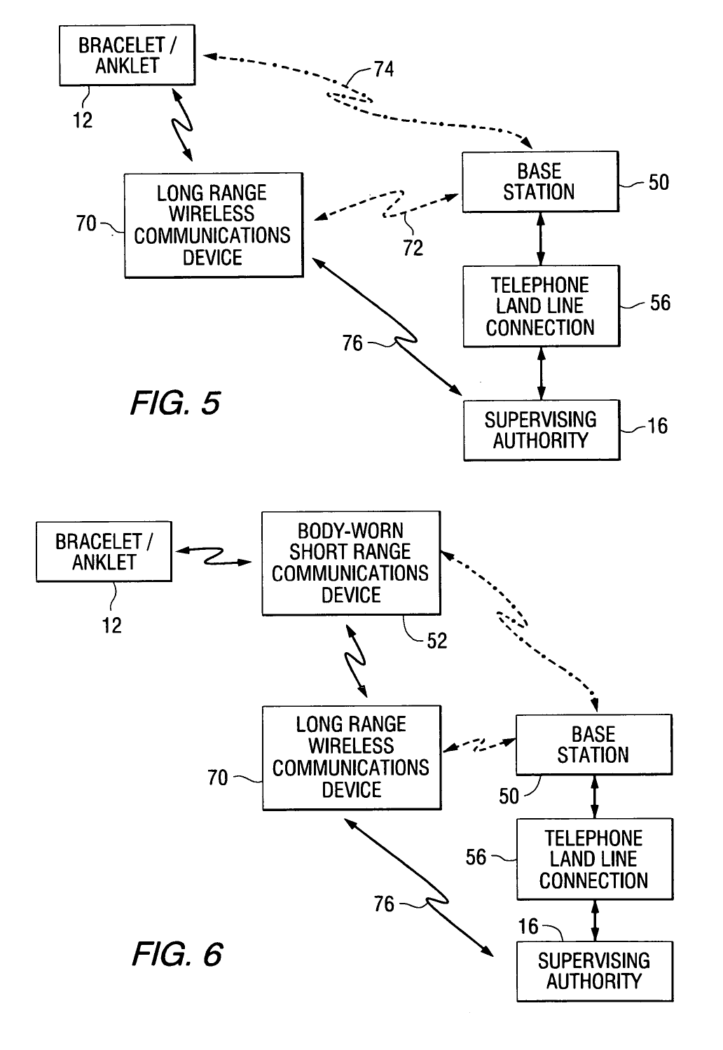

According to another embodiment as illustrated in FIG. 5, the present invention teaches a house arrest apparatus comprising a long range wireless communications device 70 that provides a communications link 76 between the anklet/bracelet 12 and the supervising authority 16, permitting wearer tracking when out of communications range from a fixed base station. According to this embodiment, the long range wireless communications device 70, such as a cellular, PCS or trunked radio subscriber unit, provides both location information (such as by use of a GPS receiver or terrestrial-based systems) and long-range reporting/monitoring by communicating with the anklet/bracelet 12 when the wearer is out-of-range (assuming such is permitted) of the base station 50 or in a system that excludes the base station 50. The communications device 70 comprises an off-the-shelf Cellular or PCS device or ‘Blackberry’ type device that is Bluetooth and/or 802.11 enabled, as non-limiting examples. Such devices are currently capable of running Java, pocket PC, or Palm OS applications software to provide the specific functionality required. Future devices are anticipated to provide similarly applicable programmability. This embodiment avoids the need to design a purpose-specific long range communications device, and can allow data delivery to the supervising authority via a connection based, “IP based”, or comparable wireless path. Wimax protocol devices may be especially suited to this application, particularly if they are also Bluetooth or similarly enabled. The long range communications device 70 need not be a voice-capable phone.

Any of the various embodiments described herein can use GPS enabled cellular, PCS or trunked phones that employ “Assisted GPS” or “Enhanced GPS” information provided by the cellular network to improve location determination, especially inside a building or a vehicle.

In another embodiment (illustrated by the dashed arrowhead 72 in FIG. 5) in lieu of communicating with the anklet/bracelet 12, the long range wireless communications device 70 communicates with the base station 50, which in turn communicates with the supervising authority 16. The communications device 70 can be manually or automatically controlled to communicate with the base station 70 or directly with the supervising authority 16.

In yet another embodiment, the offender's location and reporting/monitoring information is received from the base station 50 and provided to the supervising authority 16 via the long range wireless communications device 70, for example, when a wire line connection is not available between the base station 50 and the supervising authority 16.

In still another embodiment, the anklet/bracelet 24 can communicate with the base station 50 over a communications link illustrated by a dashed-dotted arrowhead 74 in FIG. 5 that in turns communicates with the long range communications device 70 over the link 72 that in turn communicates with the supervising authority 16 over the link 76. Communications with the anklet/bracelet 12 can be handed off between the base station 50 and the long range wireless communications device 70 according to known signal hand off techniques. The hand off can also be manually controlled, for example by the wearer when he/she intends to permissively out of range of the base station 50.

Alternatively, as shown in a FIG. 6 embodiment, the anklet/bracelet 12 communicates with the body-worn short range communications device 52 that in turn communicates with the long range communications device 70 to the supervising authority 16. Alternatively, the anklet/bracele12 communicates with the base station 50, wherein the base station 50 communicates with the supervising authority 16 through the land line connection 56 or through the long range wireless communications device 70.

The base station 50 and the long range communications device 70 can automatically hand off monitoring to each other, using a bidirectional Bluetooth, proprietary or other communications link, or in response to a user command when leaving the home or office site of the fixed base station 50. In this way, the offender's position is continuously monitored. In the event of a deviation, the enhanced 911 functionality (or other location determining techniques) of the long range wireless communications device 70, or associated cellular system, could be used to confirm the position of the wearer.

If the anklet/bracelet 12 comprises a bidirectional protocol, it can provide a status indication to the wearer that it is in communications with the base station 50, the short range communications device 52 and/or the long range communications device 70 in the various embodiments described herein. As a non limiting example, such status could also include such items as presence of the short and/or long range communications devices 52/70, battery state of the device(s), presence of local beacons (both for permitted and exclusion areas), GPS-sensed departure from permitted areas or proximity to an exclusion area, loss of location information, handoff between fixed and portable base stations, relayed messages (to contact a probation officer, etc.) and so on. If the bracelet/anklet 12 senses a status condition that requires immediate attention, (if for example it cannot establish two way communication with the monitoring device, i.e., the base station 50, the short range communications device 52 and/or the long range communications device 70, it may provide a local alarm (beep, vibration, etc.) to the wearer, allowing him/her to quickly correct the situation before a false alarm is sent to the supervising authority.

According to other embodiments, the long range wireless communications device 70 or the short range communications device 52 includes a position location device, such as a GPS receiver. According to any of these embodiments, the base station 50 is therefore not required to define a permitted range for the offender. Instead, the offender's absolute position is determined and provided to the supervising authority 15, where it is determined whether the offender is in a permitted location.

Under certain operating conditions the GPS receiver will be unable to determine the offender's location, due for example to an inability to receive signals from the GPS satellites, and a location cannot be determined using the Cellular system. Such a situation represents a limitation on the system, as a location fix is mandatory to determine whether the offender has traveled into a prohibited area or left a permitted area.

Thus a further embodiment relies on one or more fixed (with respect to location, that is) wireless devices (beacons) in the offender's home, vehicle, office, and/or other permitted locations. These devices serve as position providers to the communications device 52 and 70 when the GPS signals are not available. As an example, one or more such devices locked in fixed locations (or otherwise tamper detecting to prevent moving them in an unauthorized manner) throughout a home or office confirm that the user was within range of at least one of them, thus confirming the user's presence within a permitted area, albeit, the communications devices 52 and 70 are obscured from receiving GPS signals from the orbiting GPS satellites. A similar device, located in the user's vehicle, would not necessarily require being fixed to that vehicle, but would include a GPS receiver to provide good-quality fixes for the communications devices 52 and 70 while the latter was operated inside the vehicle, without a clear view of the sky (due to the metallic vehicle structure), enhancing the ability to provide position fixes while in the vehicle.

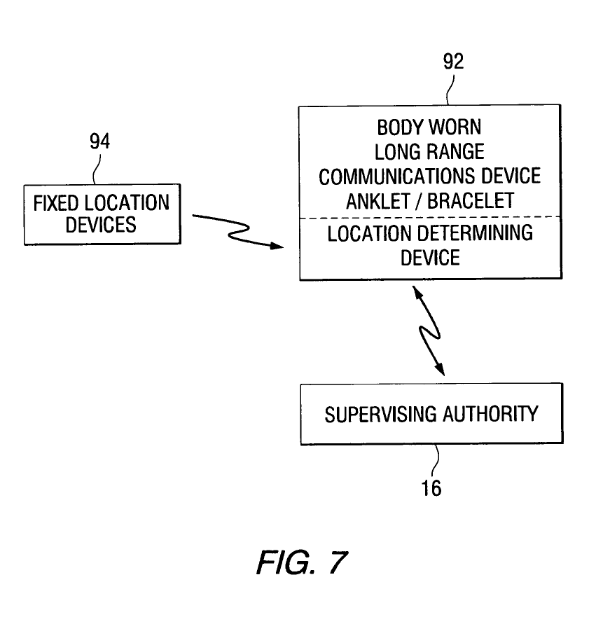

Another embodiment illustrated in FIG. 7 eliminates a separate body worn communications device and its communication link to the communication devices 52 and 70, using instead a single body worn device 90 with long range communications capability to the supervising authority 16. This device 90 communicates with fixed location devices 94 disposed within the user's authorized locations to supplement its own location determining capabilities. The device 90 can further communicate with optional vehicle-mounted devices to enhance its GPS capability when operating in a mobile application. The latter embodiment may be important when the wearer is driving with a bracelet/anklet, where the bracelet/anklet is under the dashboard near the pedals, likely precluding GPS operation.

In another embodiment, various links to the supervising authority 16 as described above comprise an IP (Internet protocol) based communications link such as a cable modem or a digital subscriber line (DSL) modem, in conjunction with a wired Ethernet connection between the base station and the cable or DSL modem.

In another embodiment the bidirectional signals between a wireless hub (for example, one operating according to one of the 802.11 protocols) and the base station or the body-worn device can be used to determine whether the body worn device is within a defined range of the hub. Thus the wireless hub operates as an above-described beacon. For those wireless hubs assigned a fixed IP address, the location of the hub can be determined by associating the wireless hub fixed IP address included with its data packets with its known geographical address. One such data packet indicates that the body worn device is within the defined range. Once the location of the hub is determined from the data packet received at the supervising authority, it is known that the body worn device is within the defined range of the hub. Alternatively, the location of the wireless hub can be determined using an Ethernet-enabled GPS receiver operative in conjunction with the hub or according to a caller-identification technique for those hubs connected to the supervising authority through a DSL modem and the telephone lines. The hub then sends data packets to the supervising authority identifying its location and that the body worn device is within the defined range.

As is known by those skilled in the art, bidirectional links illustrated in the various embodiments above can be replaced by unidirectional links in an embodiment where it is necessary to transfer data between two communicating devices in only one direction. Similarly, illustrated unidirectional links can be replaced by bidirectional links in the various embodiments. The references to specific satellite, terrestrial, wired or wireless protocols or transmission media are not intended to be limiting, as the inventive features can be applied to any wired, wireless, infrared, satellite or terrestrial signal protocols. Further the beacons referred to in the various embodiments of the invention include both beacons or transmitters that transmit information at determined intervals and beacons or transmitters that operate as transponders, i.e., transmitting a signal responsive to an interrogation or query, such as from a body worn device, e.g., an anklet or bracelet.

Although described in the context of locating an offender, the teachings of the present invention can also be employed to determine the location of an animal or to determine that a person has not wandered beyond a specified distance from a specified location.

While the invention has been described with reference to preferred embodiments, it will be understood by those skilled in the art that various changes may be made and equivalent elements may be substituted for elements thereof without departing from the scope of the invention. The scope of the present invention further includes any combination of the elements from the various embodiments set forth herein. In addition, modifications may be made to adapt a particular situation to the teachings of the present invention without departing from its essential scope.

What is claimed is:

1. A system for monitoring a location of an object, comprising;
a first device affixed to the object and comprising a first communications device;
a second communications device for communicating with the first communications device, the first communications device having a shorter range than the second communications device; and
a base station for communicating with the second communications device, wherein a location of the base station is known, and wherein responsive to a signal from the second communications device the base station determines that the object is proximate the location.

2. A system for monitoring a location of an object, comprising;
a first device affixed to the object and comprising a communications device;
a locating device proximate the first device to determine location, the locating device in communications range of the first device for supplying location information to the communications device; and
the communications device for sending the location information to a monitoring station for determining whether the object is in a permitted location.

3. The system of claim 2 wherein the locating device comprises a transmitting device for transmitting the location information to the communicating device, wherein the location information is based on a fixed location of the transmitting device or the location information is determined by the transmitting device responsive to signals received at the transmitting device.

4. The system of claim 3 wherein the signals received at the transmitting device comprise GPS signals or terrestrial signals.
